(19) United States
(12) Patent Application Publication
(10) Pub. No.: US 2017/0098467 A1
(43) Pub. Date: Apr. 6, 2017

(54) METHOD AND APPARATUS FOR DETECTING FRAME SYNCHRONICITY BETWEEN MASTER AND ANCILLARY MEDIA FILES

(71) Applicant: THOMSON LICENSING, Issy de Moulineaux (FR)

(72) Inventor: Morgan HOLLY, Los Angeles, CA (US)

(21) Appl. No.: 14/873,355

(22) Filed: Oct. 2, 2015

(51) Int. Cl. G11B 27/32; G11B 27/028; G06F 17/30

(52) U.S. Cl. CPC G11B 27/326; G06F 17/3056; G11B 27/028

(57) ABSTRACT

A method for detecting frame synchronicity between master and ancillary media files commences by detecting event changes in an ancillary media file and logging frame information associated with such event changes. The frame information associated with such event changes in the ancillary file is compared to frame information associated with event changes in the master file. Frame synchronicity between the master and ancillary files is established if the information for the ancillary file matches the frame information for the master file.

### TECHNICAL FIELD

This invention relates to a technique for establishing frame synchronicity between different media files.

### BACKGROUND ART

Today, media production makes use of digital files, thus giving raise to tapeless workflows. Such tapeless workflows require frame synchronism between master and ancillary files. Current validation procedures require a manual check by an operator utilizing a non-linear editor. Errors can cascade if anomalies go unnoticed and uncorrected before sending files for archival and production.

Thus, a need exists for an automated solution for synchronization verification.

### BRIEF SUMMARY

In accordance with the present principles, there is provided a method for detecting frame synchronicity between master and ancillary media files, each having successive frames. The method commences by detecting event changes in an ancillary media file and logging frame information associated with such event changes. The frame information associated with such event changes in the ancillary file is compared to frame information associated with event changes in the master file. Frame synchronicity between the master and ancillary files is established if the information for the ancillary file matches the frame information for the master file.

### BRIEF DESCRIPTION OF THE DRAWINGS

FIG. 1 depicts a block schematic diagram of an exemplary apparatus for practicing the frame synchronization determination technique of the present principles;

FIG. 2 depicts in flow chart form the steps of a method for cataloging an audio/video files; and

FIG. 3 depicts in flow chart form the steps of a method for determining frame synchronization between a master and ancillary file in accordance with the present principles.

### DETAILED DESCRIPTION

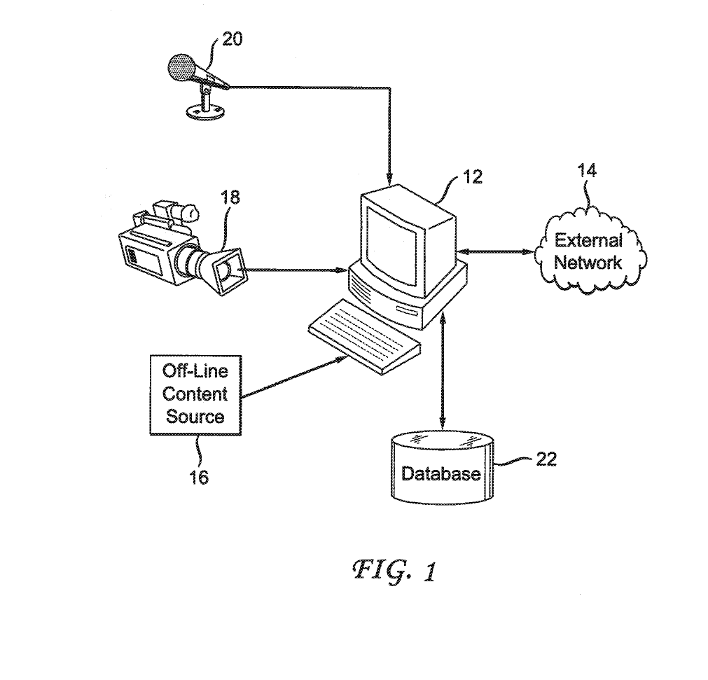

FIG. 1 depicts a block schematic diagram of an exemplary system 10 for determining frame synchronization between master files and ancillary files. The files can comprise audio-video files, video only files or audio only files associated with movies, television programs, electronic games or other media assets. The system 10 includes a computer 12, illustratively illustrated as a personal computer, including both a display as well as a keyboard. The computer 12 also can include other data input devices such as a mouse and/or joystick (not shown) as well one or more network interface mechanisms (not shown) to allow the computer to interface to one or more external devices and/or networks as described.

The computer 12 can receive master and/or ancillary files from a variety of sources. For example, the computer 12 can receive master and/or ancillary files, e.g., audio-video files, video-only files and/or audio-only files from an external network 14 including but not limited to the Internet. In addition, the computer 12 can receive master and/or ancillary files (audio-video files, video-only files and/or audio-only files) from an off-line content source 16. Further, the computer 12 can receive live master and/or ancillary files in the form of video output by a camera 18 and/or audio output by a microphone 20.

The computer 12 has access to a database 22 that can store the master and/or ancillary files as well as other information in connection with determining frame synchronization as described hereinafter. As depicted in the illustrative embodiment of FIG. 1, the database 22 appears as a discrete element separate from the computer 12 but could be integral with the computer in other embodiments.

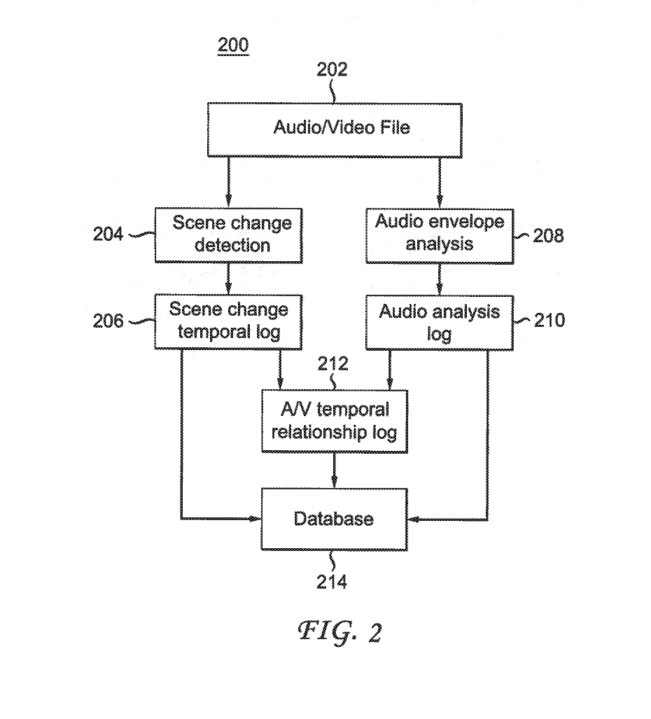

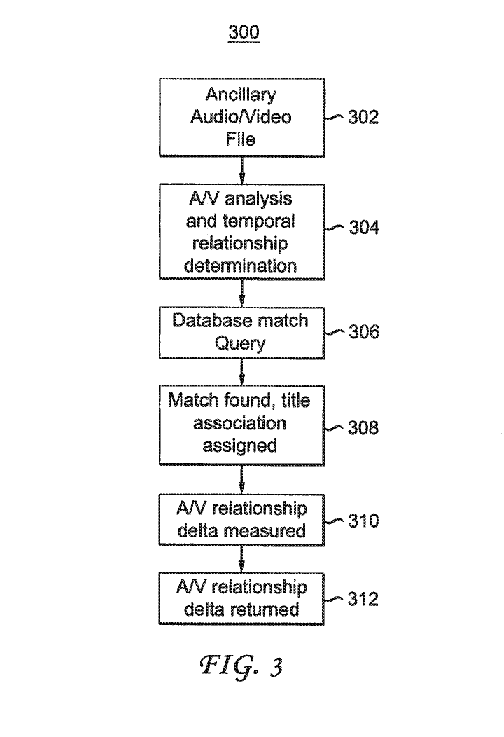

As described in greater detail with respect to FIGS. 2 and 3, the computer 12 establishes frame synchronization between master and ancillary files in accordance with file signatures that reflect event changes in the file. Every piece of content (i.e., every master and ancillary file) has a unique signature. Video files have a unique temporal signature based on scene changes in the file. The computer 12 can detect scene changes in video in the master and ancillary files and log the frames where such changes occur, as well as the number of frames (e.g., the frame count) between such changes. The computer 12 logs such frame information associated with scene changes in the database 22 and/or other storage device (not shown). For a master file, the frame information serves as a master list. For ancillary (children) files, the computer 12 compares the frame information to the master list. Thus for example, the computer 12 could match the actual frames where such changes occurred in the master file to the corresponding frames where changes occurred in the ancillary file to establish (i.e., determine) frame synchronicity between the video in the master and ancillary files. If there are no discrepancies (or the discrepancies lie below a set threshold), the ancillary file is considered in sync with the master file. If the frame number is not in the master list, a new list is created to log these discrepancies.

Assuming the logging of the frame counts between scene changes (either in addition to, or in place of logging individual frames); the computer 12 could compare the frame counts between scene changes in the master and ancillary files to establish frame synchronicity. Using frame counts rather than individual frames as the measure of comparison affords the advantage of determining the degree of offset if any between the master and ancillary files. Should a comparison between the frame counts of successive scene changes in the master files and the ancillary file yield a fixed difference that does not change, then an offset likely exists between the master and ancillary files, thereby allowing automatic or manual trimming to resolve the offset.

Audio, associated with the master file or a reference file, with sufficient resolution undergoes storage in the database 22 or another storage device (not shown) for use as a baseline. The computer 12 can measure and map the acoustic signature (e.g., significant acoustic events) of the audio to the temporal video signature of the master file. Further, the computer 12 can measure the phase correlation between the audio of an associated master file and the audio of an ancillary file audio to determine synchronization. Ancillary files with a deviation greater than a threshold number of samples (e.g., 1,400 samples) will be considered out of synchronization.

The computer 12 can also compare the temporal signature of master files to master titles in the database 22 to identify individual feature or episodic titles. Thus, the system 100 can ingest titles and thereafter automatically associate such files with their parent assets.

FIG. 2 depicts in flow chart form the steps of a method 200 executed by the computer 12 of FIG. 1 to catalog master and ancillary files, e.g., audio-video assets, to establish their signature for subsequent comparison to establish frame synchronization. First, the computer 12 receives a file (e.g., audio-video asset) during step 202. Next, the computer 12 establishes a temporal signature for the video of the received file by detecting scenes changes during step 204. For each such scene change, the computer 12 logs either or both the occurrence of that scene change (e.g., the frame in which the change occurred) in a temporal log during step 206, along with a frame count between scene changes. For example, the temporal log might reflect a frame count of 230 frames between a first and second scenes changes and a frame count of 541 frames between second and third scenes, etc.

In addition to detecting the temporal signature of the video of the received file, the computer 12 performs an analysis of the audio of that file to establish the acoustic signature during step 208. Typically, the computer 12 establishes the acoustic signature by detecting acoustic events in the audio. Thereafter, the computer 12 logs such acoustic events to establish an audio analysis log during step 210. As depicted in FIG. 2, the sequence of steps 208 and 210 can occur at the same time as the sequence of steps 204 and 206. Alternatively, the sequence of steps 208 and 210 could occur before or after the sequence of steps 204 and 206.

After logging the temporal scene changes during step 206 and logging the acoustic events during step 208, the computer 12 maps the temporal scene changes to the acoustic events during step 212 to create an A/V temporal log recorded in the database 22 (or other storage device) during step 214.

FIG. 3 depicts in flowchart form the steps of a method 300 for establishing (e.g., determining) frame synchronization between a master and ancillary file. Initially, the computer 12 obtains the ancillary file during step 302. Typically, the ancillary file obtained during step 302 comprises an audio-visual asset, although the ancillary file could consist of only video or audio. After obtaining the ancillary file, the computer 12 then analyzes that file during step 304 to establish the ancillary file's temporal and acoustic signatures as discussed in connection with the steps of the method 200 of FIG. 2. For video-only and audio-only ancillary files, the computer 12 will only establish the temporal and acoustic signatures, respectively. Following step 304, the computer 12 matches the ancillary file to a corresponding master file stored in the database 22 (or other storage device) during step 306. Assuming a match, the computer 12 then will assign (e.g., establish) an association between the titles of master and ancillary files during step 308.

Following step 308, the computer 12 measures (e.g., establishes) the temporal and/or acoustic signature of the ancillary file during step 310 for comparison to the master file for the purpose of establishing (determining) frame synchronization. As discussed above in connection with FIG. 2, the computer 12 determines event changes (e.g., scene changes and/or acoustic changes) of both the master and ancillary files and records frame information associated with such event changes. In this way, the computer 12 can compare the frame information (either the actual frame where the event change occurred or the frame count between event changes) against frame information associated with event changes in the master file. Following such comparison, the computer 12 can establish whether a difference exists between the frame information for the ancillary file and the master file during step 312. If the difference lies below a target threshold, (e.g., substantially no difference) then the master file and ancillary file exist in frame synchronization.

As discussed above, using the frame counts associated with the successive event changes provides a mechanism for determining whether an offset exists between the master and ancillary files. If such an offset exists, automatic or manual trimming of the ancillary file can occur to obviate the offset.

The foregoing describes a technique for establishing frame synchronism between master and ancillary files.

1. A method for determining frame synchronicity between master and ancillary media files each having successive frames, comprising:
detecting event changes in an ancillary media file and logging frame information associated with event changes;
comparing the frame information associated with event changes in the ancillary file to frame information associated with event changes in the master file,
establishing frame synchronicity between the master and ancillary files when frame information for the ancillary file matches the frame information for the master file.

2. The method according to claim 1 wherein the master and ancillary files both include video and the event changes in the ancillary file and the master file include scene changes.

3. The method according to claim 1 wherein the master and ancillary files both include audio and the event changes in the ancillary file and the master file include acoustic event changes.

4. The method according to claim 1 wherein the frame information includes a frame count between event changes.

5. The method according to claim 4 further including the step of determining whether a fixed difference exists between frame counts for event changes in the ancillary file as compared to the master file to determine if an offset exists therebetween.

6. Apparatus for determining frame synchronicity between master and ancillary media files each having successive frames, comprising:
a database for storing master and ancillary files; and
a computer coupled to the database and configured to (a) detect event changes in an ancillary media file and log frame information associated with event changes; (b) compare the frame information associated with event changes in the ancillary file to frame information associated with event changes in the master file, and (c) establish frame synchronicity between the master and ancillary files when frame information for the ancillary file matches the frame information for the master file.

7. The apparatus according to claim 6 wherein the master and ancillary files both include video and the event changes in the ancillary file and the master file include scene changes.

8. The apparatus according to claim 7 wherein the master and ancillary files both include audio and the event changes in the ancillary file and the master file include acoustic event changes.

9. The apparatus according to claim 7 wherein the frame information includes a frame count between event changes.

10. The apparatus according to claim 9 wherein the computer is further configured to determine whether a fixed difference exists between frame counts for event changes in the ancillary file as compared to the master file to determine if an offset exists therebetween.
